(19) United States
(12) Patent Application Publication
(10) Pub. No.: US 2006/0113504 A1
(43) Pub. Date: Jun. 1, 2006

(54) Quick release hinge assembly

(75) Inventor: Jeff Tollin, E. Rockaway, NY (US)

Correspondence Address: LACKENBACH SIEGEL, LLP, LACKENBACH SIEGEL BUILDING, 1 CHASE ROAD, SCARSDALE, NY, 10583, US

(73) Assignee: China Cat, Inc.

(21) Appl. No.: 11/001,285

(22) Filed: Dec. 1, 2004

(51) Int. Cl. F16K 31/44

(52) U.S. Cl. 251/257

(57) ABSTRACT

A quick attachment and release assembly enables ready attachment of a variety of seat combinations to a variety of ceramic supports with variable depth and diameter attachment holes. A cam assembly with a lever arm enables compression of at least one elastomeric sleeve positioned about a central shaft after insertion within an attachment hole. During compression the one or more elastomeric sleeves expand outwardly gripping walls of the hole and fixing a pivoting flange of the seat relative to the hole. Adaptive embodiments enable the use of additional spacers and adjustable-length bottom stops to adapt the present invention to a variety consumer needs and differently manufactured ceramic supports.

### BACKGROUND OF THE INVENTION

1. Field of the Invention

The present invention relates to a quick release assembly for a commode or toilet seat. More specifically, the present invention relates to a quick release hinge assembly employing a cam and compression system that is easily used with existing seat hinge and commode designs providing simple employment and an attractive appearance.

2. Description of the Related Art

A wide verity of hinge mechanisms, toilet seats, and combinations thereof have been created to deal with consumer demands for security and stability, easy removal (quick release), easy replacement upon breakage and a clean visual appearance. These mechanisms provide solutions spanning nearly the entire twentieth century and follow the evolution of the toilet mechanism itself. A brief selection of these references follows.

A substantial number of these mechanisms provide solutions for easy replacement or removal and corresponding stability concerns, and include: U.S. Pat. No. 4,319,365 to Bemis, U.S. Pat. No. 2,593,534 to Campanelli, U.S. Pat. No. 3,063,063 to Brooks; U.S. Des. No. D377,306 to Decker, U.S. Pat. No. 3,055,015 to Silverman, U.S. Pat. No. 3,653,077 to Warnberg, U.S. Pat. No. 3,082,000 to Waldon, U.S. Pat. No. 3,613,130 to Sansone, U.S. Pat. No. 3,471,874 to Dixon, U.S. Pat. No. 4,367,567 to Sandoykas, U.S. Pat. No. 5,267,357 to Ades, U.S. Pat. No. 5,396,663 to Burgess, U.S. Pat. No. 5,414,875 to Kappl et al., U.S. Pat. No. 5,638,554 to Corzine, U.S. Pat. No. 6,070,295 to Helsebus, U.S. Pat. No. 6,071,034 to Cavagna, U.S. Pat. No. 6,101,640 to Brewer et al., U.S. Pat. No. 6,338,167 to Baker et al., U.S. Pat. No. 6,381,762 to Moser, U.S. Pat. No. 6,643,851 to Janes, U.S. Pub. No. 2001/0013143 A1 to Cavagna, U.S. Pub. No. 2004/0064876 A1 to Lu, U.K. App. No. 2 067 650 A to Baillie et al, DE Pat. No. DE4339200 to Burkard, and DE Pat. No. DE19958371 to Joerg et al.

Additional references focus on the hinge itself, or the hinge joint between the seat and lid. These references include: U.S. Pat. No. 4,133,061 to Hurd, U.S. Pat. No. 4,173,802 to Wikstrom, U.S. Pat. No. 4,159,548 to Hewson, U.S. Pat. No. 4,353,137 to Jammet, U.S. Pat. No. 4,688,274 to Ginsburg et al., U.S. Pat. No. 4,680,816 to Colombani, U.S. Pat. No. 4,688,274 to Grimstad, U.S. Pat. No. 4,965,889 to Tissot et al., U.S. Pat. No. 4,974,262 to Rosen, U.S. Pat. No. 5,175,891 to Ohshima et al., U.S. Pat. No. 5,515,552 to Tolsma, U.S. Pat. No. 5,901,383 to Yanagawa et al., U.S. Pat. No. 5,933,875 to Hulsebus et al., U.S. Pat. No. 5,980,150 to Newman et al., U.S. Pat. No. 6,421,842 to Fujita, U.S. Pat. No. 6,453,478 to Semmler, and U.S. Pat. No. D358,973 to Spaeth.

While the long list of references above provides a range of solutions to the concerns noted above, none provides the unique benefits and operation of the present design.

### OBJECTS AND SUMMARY OF THE INVENTION

An object of the present invention is to provide a quick release or easy engagement hinge mechanism.

Another object of the present invention is to provide a quick release or engagement mechanism that is operable by a wide number of users and provides a pleasing appearance.

Another object of the present invention is to provide a quick release hinge assembly that is reasonably cost effective to produce inexpensive to a customer.

The present invention relates to a quick attachment and release assembly that enables ready attachment of a variety of seat combinations to a variety of ceramic supports with variable depth and diameter attachment holes. A cam assembly with a lever arm enables compression of at least one elastomeric sleeve positioned about a central shaft after insertion within an attachment hole. During compression the one or more elastomeric sleeves expand outwardly gripping walls of the hole and fixing a pivoting flange of the seat relative to the hole.

Adaptive embodiments enable the use of additional spacers and adjustable-length bottom stops to adapt the present invention to a variety consumer needs and differently manufactured ceramic supports.

According to an embodiment of the present invention there is provided an assembly, comprising: a seat member having an attachment member with a first opening, a seat support having a seat attachment hole, a quick release/attachment assembly projecting through the first opening and into the attachment hole, the quick release/attachment assembly, further comprising: a lever arm having a first cam member with a first cam surface, a central shaft extending from a pivot point of the lever arm at a proximate end to a bottom stop at a distal end, a stability member about the central shaft proximate the proximate end having a second cam surface proximate the first cam surface, and an elastomeric sleeve about the central shaft between the bottom stop and the stability member, whereby when the lever arm actuates the first cam surface along the second cam surface, the bottom stop is drawn toward the pivot point compressing the elastomeric sleeve and bulging the sleeve to grip walls of the seat attachment hole and join the seat attachment member to the seat support.

According to another embodiment of the present invention, there is provided an assembly further comprising: a cover cap member, and means for positioning the cover cap member covering a portion of the lever arm and the quick release/attachment assembly, whereby the cover cap member provides a pleasing visual appearance after installation.

According to another embodiment of the present invention, there is provided an assembly further comprising: an opening on the cover cap member, and a portion of the lever arm projecting through the opening enabling the cover cap member to provide the pleasing visual appearance while retaining a compact shape.

According to another embodiment of the present invention, there is provided a quick release/attachment assembly, comprising: a lever arm having a first cam member with a first cam surface, central shaft extending from a pivot point of the lever arm at a proximate end to a bottom stop at a distal end, stability member about the central shaft proximate the proximate end having a second cam surface proximate the first cam surface, an elastomeric sleeve about the central shaft between the bottom stop and the stability member, whereby when the lever arm actuates the first cam surface along the second cam surface, the bottom stop is drawn toward the pivot point compressing the elastomeric sleeve and bulging the sleeve to grip walls of an external seat attachment hole and join an external seat attachment member to an external seat support, a cover cap member, and means for positioning the cover cap member covering a portion of the lever arm and the quick release/attachment assembly, whereby the cover cap member provides a pleasing visual appearance after installation.

According to another embodiment of the present invention, there is provided a quick release/attachment assembly, further comprising: an opening on the cover cap member, and a portion of the lever arm projecting through the opening enabling the cover cap member to provide the pleasing visual appearance while retaining a compact shape.

According to another embodiment of the present invention, there is provided an assembly, comprising: a seat member having an attachment member with a first opening for joining with an external seat support having an attachment hole, a quick release/attachment assembly projecting through the first opening and into the attachment hole, the quick release/attachment assembly further comprising: a lever arm having a first cam member with a first cam surface, a central shaft extending from a pivot point of the lever arm at a proximate end to a bottom stop at a distal end, a stability member about the central shaft at the proximate end having a second cam surface proximate the first cam surface, and an elastomeric sleeve on the central shaft between the bottom stop and the stability member, whereby when the lever arm actuates the first cam surface along the second cam surface, the bottom stop is drawn toward the pivot point compressing the elastomeric sleeve and bulging the sleeve away from the central shaft to grip walls of the seat attachment hole and join the seat attachment member to the seat support.

According to another embodiment of the present invention, there is provided a method for affixing a toilet seat to a support, comprising the steps of: providing a seat member having an attachment member with at least a first opening, positioning the seat member on a seat support having at least one seat attachment hole, aligning the first opening with the seat attachment hole, inserting a quick release/attachment assembly through the first opening and into the attachment hole, the quick release/attachment assembly further comprising: a lever arm having a first cam member with a first cam surface, a central shaft extending from a pivot point of the lever arm at a proximate end to a bottom stop at a distal end, stability member about the central shaft at the proximate end having a second cam surface proximate the first cam surface, and an elastomeric sleeve about the central shaft between the bottom stop and the stability member, whereby when the lever arm actuates the first cam surface along the second cam surface, the bottom stop is drawn toward the pivot point compressing the elastomeric sleeve and bulging the sleeve to grip walls of the seat attachment hole and join the seat attachment member to the seat support.

According to another embodiment of the present invention, there is provided an attachment and adjustment kit, comprising: a first member having an attachment member with a first opening for joining with an external first support having an attachment hole, a quick release/attachment assembly projectable through the first opening and into the attachment hole during an assembly, the quick release/attachment assembly further comprising: a lever arm having a first cam member with a first cam surface, a central shaft extending from a pivot point of the lever arm at a proximate end to a bottom stop at a distal end, means for adjusting a position of the bottom stop on the central shaft relative to the pivot point thereby allowing the quick release/attachment assembly to adapt to differing length attachment holes in the seat support, stability member about the central shaft at the proximate end having a second cam surface proximate the first cam surface, at least one elastomeric sleeve on the central shaft between the bottom stop and the stability member, and thereby when the lever arm actuates the first cam surface along the second cam surface, the bottom stop is drawn toward the pivot point compressing the elastomeric sleeve and bulging the sleeve away from the central shaft to grip walls of the seat attachment hole and join the seat attachment member to the seat support.

According to another embodiment of the present invention, there is provided an attachment and adjustment kit, further comprising: at least one spacer on the central shaft, and the at least one spacer being one of proximate the bottom stop and proximate the stability member.

According to another embodiment of the present invention, there is provided an attachment and adjustment kit, wherein: the means for adjusting includes a threaded connectability between the central shaft and the bottom stop, thereby allowing the bottom stop to be threadably adjusted along a length of the central shaft.

According to another embodiment of the present invention, there is provided an attachment and adjustment kit, wherein: the elastomeric sleeve is at least one of a cylendraceous member, a hexagonal member, an octagonal member enabling simple operation and formation, and an external surface of the elastomeric sleeve is at least one of a smooth surface, a roughened surface, a patterned surface, a particulate surface enabling firm fixing to a surface during use.

According to another embodiment of the present invention, there is provided a kit, comprising: a quick release/attachment assembly comprising a lever arm having a first cam member with a first cam surface, a central shaft extending from a pivot point of the lever arm at a proximate end to a bottom stop at a distal end, means for removing and adjusting a position of the bottom stop on the central shaft relative to the pivot point thereby allowing the quick release/attachment assembly to adapt to differing length operations, a stability member about the central shaft at the proximate end having a second cam surface proximate the first cam surface, at least one elastomeric sleeve on the central shaft between the bottom stop and the stability member, and thereby when the lever arm actuates the first cam surface along the second cam surface, the bottom stop is drawn toward the pivot point compressing the elastomeric sleeve and bulging the sleeve away from the central shaft to grip walls of the seat attachment hole and join the seat attachment member to the seat support.

According to another embodiment of the present invention, there is provided a kit further comprising: a cover cap member, and means for positioning the cover cap member covering a portion of the lever arm and the attachment assembly, whereby the cover cap member provides a pleasing visual appearance after installation.

According to another embodiment of the present invention, there is provided a kit further comprising: an opening on the cover cap member, and a portion of the lever arm projecting through the opening enabling the cover cap member to provide the pleasing visual appearance while retaining a compact shape.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a partially cut-away perspective view of one embodiment of the present invention.

FIG. 2 is a top view of the embodiment shown in FIG. 1.

FIG. 3 is a partial sectional view of FIG. 1 along line 3-3.

FIG. 4 is a partially cut-away perspective view of another embodiment of the present invention.

FIG. 5 is a partial sectional view of FIG. 4 along line 5-5 splitting the central shaft and the quick release attach assembly.

### DETAILED DESCRIPTION OF THE PREFERRED EMBODIMENTS

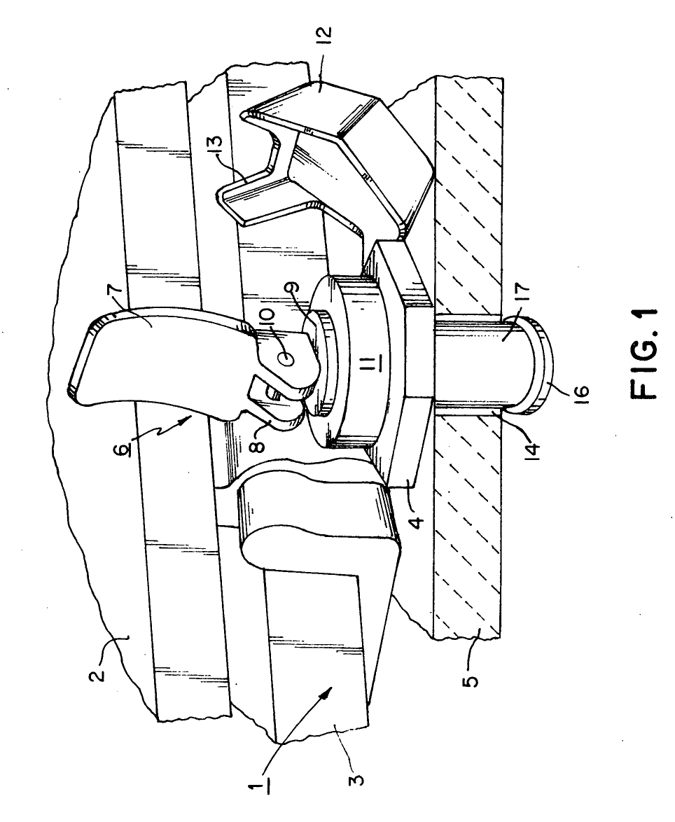

Referring now to FIGS. 1-3, a seat hinge assembly 1 includes at least a pivoting seat flange 4 and a quick attach/release assembly 6. A seat top 2 and a seat bottom 3 are pivotally joined to pivoting seat flange 4 in a conventional manner.

Hinge assembly 1 rests on a ceramic or other support 5 relative to a plurality of holes 14 conventionally supplied by a manufacturer for seat attachment and securement. As shown, flange 4 extends from a pivoting attachment of seat top 2 and seat bottom 3 and is positionable relative a relative hole 14, as shown. A cover cap 12 with a cap opening 13 is pivotally joined to flange 4 and facilitates an attractive covering or partial covering of quick attach/release assembly 6 as will be described.

Quick attach/release assembly 6 includes a central shaft 15 joining a bottom stop member 16 and an upward pivot point or pivot axis 10. A lever arm 7 is pivotally attached relative to pivot 10 (a pivot point/axis) and rotates relative thereto. Pivot axis 10 is aligned with a center of central shaft 15, thereby optionally allowing lever arm 7 to rotate relative to central shaft 15. A stop washer or stability member 11 pivotally encircles central shaft 15 as shown and optionally includes a second cam surface 9. Lever arm 7 includes a cam member 8 with a first cam surface 8a. As shown, during operation, lever arm 7 rotates relative to pivot point 10 and slides cam member 8 along cam surface 8a relative to second cam surface 9 which effectively shortens a distance between stop washer or stability member 11 and bottom stop 16.

While lever arm 7 is shown with a shortened and broadened end, any type of ending would be sufficient to operate quick attach/release assembly 6. In the preferred embodiment shown, the end of lever arm 7 is shortened and broadened for convenient finger use and force application in a small space. Ridges (shown but not numbered) may be employed to minimize user-finger slipping during application.

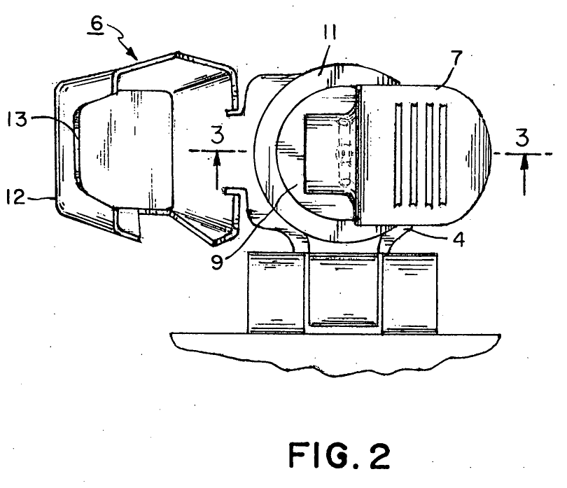

As can be seen most advantageously in FIG. 2, cover cap 12 is joined to pivoting flange 4 and allows cover cap 12 to pivot up and over lever arm 7 after use. In alternative embodiments cover cap 12 may be joined to stability member 11 for convenience and separate sale.

A cap opening 13 surrounds a later portion of lever arm 7 to provide a pleasing appearance and allow simple cleaning. In this manner, cover cap 12 prevents debris from surrounding quick attach/release assembly 6 and making cleaning difficult.

In one alternative embodiment, cover cap 12 is optionally joined with stop washer/stability surface 11 and operates as part of quick attach/release assembly 6. In this embodiment, a conventional pivoting flange 4 (without a cover cap) may be used, and assembly 6 may be provided separately for consumer convenience, for example with cover cap 12 joined to stability member 11. In this embodiment, convenience is additionally improved by allowing stop washer/stability surface 11 with cap 12 to pivot relative to central shaft 15 while simultaneously allowing lever arm 7 to similarly rotate. As a consequence, in cramped circumstances a user may position and reposition assembly 6 into a desired position.

In the embodiment shown at least one elastomeric sleeve 17 surrounds central shaft 15 between bottom stop 16 and stop washer 11. In the present embodiment, sleeve 17 has a cylindrical shape with a wall thickness, but alternative shapes are envisioned, including semi-circular, pseudo-circular, hexagonal, etc. sufficient to both expand outwardly relative to shaft 15 and to grip the inner surfaces of hole 14.

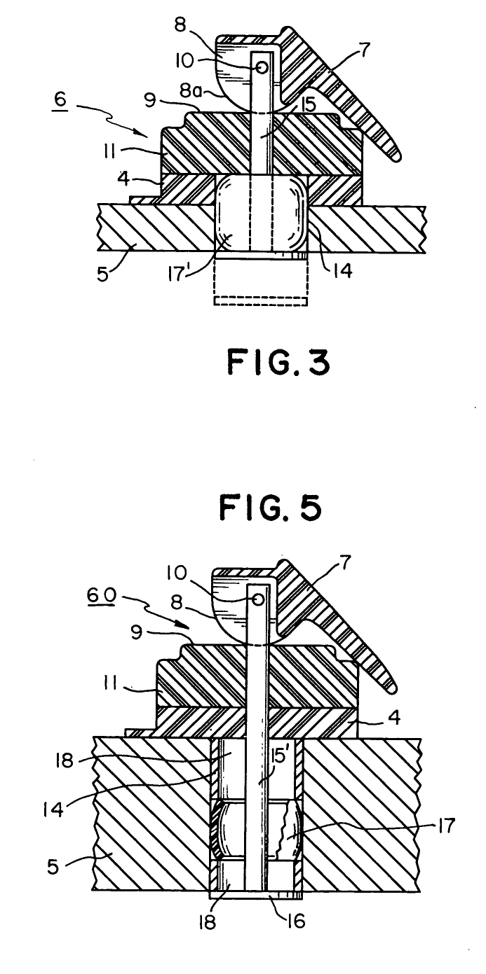

As best understood from FIG. 3, as lever arm 7 actuates to shorten the distance between bottom stop 16 and stop washer/stability member 11 compressive pressure is axially applied to elastomeric sleeve 17 causing the sleeve to bulge outwardly forming expanded sleeve 17′. During outward expansion an outer surface of expanded sleeve 17′ contacts inner surface of hole 14 placing sleeve 17 under compression and exerting substantial resistance to axial removal of quick release/attach assembly 6.

In the present embodiment elastomeric sleeve 17 has an outer surface of gripping rubber to provide a tight gripping fit upon expansion. It is envisioned, that alternative shapes (see supra.) or alternative surface textures (rough surface, aggregate coated, sliced or cut surfaces, roughened, etc.) may be used to enhance slip resistance between sleeve 17 and the inner surface of hole 14.

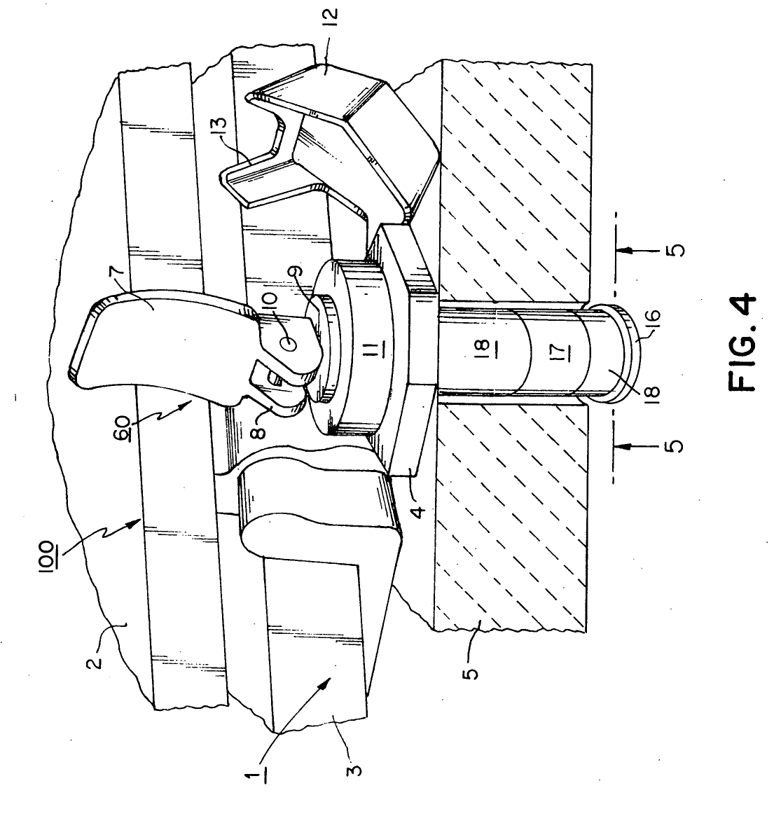

Referring now to FIGS. 4 and 5 an alternative embodiment of the present invention includes a hinge assembly 100 containing an alternative quick attach/release assembly 60 as shown. In the present embodiment it is noted that hole 14 and ceramic support 5 are thickened representing alternative types of conventional toilet casting techniques.

In the present embodiment, pivoting flange 4 pivotally joins seat top 2 and seat bottom 4 and the assembly pivotally operates in a similar manner to that described above.

In this embodiment, at least one rigid sleeve or spacer 18 is provided along an extended central shaft 15′. In the present embodiment two rigid spacers 18 are on opposite sides of elastomeric sleeve member 17 and loosely slide along and rotate about extended central shaft 15′.

Rigid spacers 18 serve to position elastomeric sleeve member 17 generally centrally within hole 14 and as lever arm 7 actuates exert compressive forces on elastomeric sleeve 17 in the manner described above.

This embodiment enables the use of uniformly shaped sleeve members 17 having the same or similar compressive strength/resistance as the embodiment described above despite the extended shaft 15′. This adaptation allows operation of quick attach/release assembly 60 by assemblers with smaller or weaker hands and minimizes damages due to over tension to ceramic support 5. As a consequence, alternative embodiments of the present invention allow easy adaptation to a variety of industry ceramic supports without requiring a user to adapt the installation process.

In another alternative embodiment, a replacement quick attach/release assembly 6 is provided as a kit wherein bottom stop 16 is fixed or optionally removably and adjustably joined (via threads or other mechanism) to central shaft 15, 15′ and allows removal and adjustment relative there to. Included in the kit are a number of different length and optionally thickness elastomeric sleeves 17, 17′ and different length and optionally thickness spacers 18. During use, a consumer would first assess the thickness of a particular ceramic support 5 and length of hole 14. Thereafter the consumer would select at least one elastomeric sleeve 17 and install it along shaft 15 and adjust (for example by thread-ably adjusting) bottom stop 16 as required. For especially deep holes 14, the consumer would employ sleeve 17 and select and install one or more spacers 18 from the kit with the goal of positioning compressive attachment of one or more expanded sleeve' 17′ generally centrally within hole 14 for maximum attachment force and resistance to movement. By employing an easily assembled kit with alternative spacers 18 and sleeves 17, a consumer may adapt the present invention to a variety of attachment conditions for maximum convenience and stability.

In another alternative embodiment spacers 18 would not be open cylinders loosely fitting about shafts 15, but would be formed in a solid body with only a single axial opening for the shaft. In this manner, the ends of elastomeric sleeve 17, 17′ are presented with and contact a solid, firm, and supporting surface during use and compression. As a consequence, the risk of elastomeric sleeve 17 expanding into a space defined between shaft 15 and an inner portion of a spacer 18 and releasing the compressive stress on hole 14, is substantially minimized by eliminating the space.

In the embodiments discussed above, stop washer/stability member 11 operates effectively to assist assembly 6 to urge pivoting flange 4 against ceramic support 5 during use and provides an additional measure of stability to seat top 2 and seat bottom 3. It should be understood therefore, that the present assembly fixes a seat to a support both by the pressure applied by the outward forces from elastomeric sleeve 17, 17′, and also by the joining pressure supplied by stop washer/stability member 11.

As further discussion it should be noted in FIG. 5, that member 4 appears to closely surrounds shaft 15′ during compression, this is optionally the case in the embodiment shown where bottom member 18 is threadably joinable to shaft 15′ and shaft 15′ is inserted via a small hole in member 4 and elastomeric sleeves and bottom member 18 are there after assembled. In this alternative manner, the present invention allows for quick adaptation to a variety of situations and constructions while adopting the basic functional aspects described above.

It should be apparent to those of skill in the art of designing consumer products that embodiments of the present invention may be readily adapted to both the initial product market (sold in combination with a seat assembly), and a product aftermarket (sold as a kit for use with an existing seat assembly). As a consequence, the present invention allows ready adaptation to a variety of market conditions and consumer requirements for product adaptation.

It should be additionally apparent to those of skill in the art that the present embodiments may be adapted to position elastomeric member 17 at a position below the ceramic support 5. In this position, during operation, as elastomeric member 17 is compressed and budges outwardly it presses on the bottom surface of ceramic support 5 exerting compressive forces. In this manner, this embodiment may be combined with previous embodiments and different configurations allowing elastomeric member 17 to be positioned within hole 14 or below hole 14 or both.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An assembly, comprising:
a seat member having an attachment member with a first opening;
a seat support having a seat attachment hole;
a quick release/attachment assembly projecting through said first opening and into said attachment hole;
said quick release/attachment assembly, further comprising:
a lever arm having a first cam member with a first cam surface;
a central shaft extending from a pivot point of said lever arm at a proximate end to a bottom stop at a distal end;
a stability member about said central shaft proximate said proximate end having a second cam surface proximate said first cam surface; and
an elastomeric sleeve about said central shaft between said bottom stop and said stability member, whereby when said lever arm actuates said first cam surface along said second cam surface, said bottom stop is drawn toward said pivot point compressing said elastomeric sleeve and bulging said sleeve to grip walls of said seat attachment hole and join said seat attachment member to said seat support.

2. An assembly, according to claim 1, further comprising:
a cover cap member; and
means for positioning said cover cap member covering a portion of said lever arm and said quick release/attachment assembly, whereby said cover cap member provides a pleasing visual appearance after installation.

3. An assembly, according to claim 2, further comprising:
an opening on said cover cap member; and
a portion of said lever arm projecting through said opening enabling said cover cap member to provide said pleasing visual appearance while retaining a compact shape.

4. A quick release/attachment assembly, comprising:
a lever arm having a first cam member with a first cam surface;
a central shaft extending from a pivot point of said lever arm at a proximate end to a bottom stop at a distal end;
a stability member about said central shaft proximate said proximate end having a second cam surface proximate said first cam surface;
an elastomeric sleeve about said central shaft between said bottom stop and said stability member, whereby when said lever arm actuates said first cam surface along said second cam surface, said bottom stop is drawn toward said pivot point compressing said elastomeric sleeve and bulging said sleeve to grip walls of an external seat attachment hole and join an external seat attachment member to an external seat support;
a cover cap member; and
means for positioning said cover cap member covering a portion of said lever arm and said quick release/attachment assembly, whereby said cover cap member provides a pleasing visual appearance after installation.

5. A quick release/attachment assembly, according to claim 4, further comprising:
an opening on said cover cap member; and
a portion of said lever arm projecting through said opening enabling said cover cap member to provide said pleasing visual appearance while retaining a compact shape.

6. An assembly, comprising:
a seat member having an attachment member with a first opening for joining with an external seat support having an attachment hole;
a quick release/attachment assembly projecting through said first opening and into said attachment hole;
said quick release/attachment assembly further comprising:
a lever arm having a first cam member with a first cam surface;
a central shaft extending from a pivot point of said lever arm at a proximate end to a bottom stop at a distal end;
a stability member about said central shaft at said proximate end having a second cam surface proximate said first cam surface; and
an elastomeric sleeve on said central shaft between said bottom stop and said stability member, whereby when said lever arm actuates said first cam surface along said second cam surface, said bottom stop is drawn toward said pivot point compressing said elastomeric sleeve and bulging said sleeve away from said central shaft to grip walls of said seat attachment hole and join said seat attachment member to said seat support.

7. A method for affixing a toilet seat to a support, comprising the steps of:
providing a seat member having an attachment member with at least a first opening;
positioning said seat member on a seat support having at least one seat attachment hole;
aligning said first opening with said seat attachment hole;
inserting a quick release/attachment assembly through said first opening and into said attachment hole;
said quick release/attachment assembly further comprising:
a lever arm having a first cam member with a first cam surface;
a central shaft extending from a pivot point of said lever arm at a proximate end to a bottom stop at a distal end;
a stability member about said central shaft at said proximate end having a second cam surface proximate said first cam surface; and
an elastomeric sleeve about said central shaft between said bottom stop and said stability member, whereby when said lever arm actuates said first cam surface along said second cam surface, said bottom stop is drawn toward said pivot point compressing said elastomeric sleeve and bulging said sleeve to grip walls of said seat attachment hole and join said seat attachment member to said seat support.

8. An attachment and adjustment kit, comprising:
a first member having an attachment member with a first opening for joining with an external first support having an attachment hole;
a quick release/attachment assembly projectable through said first opening and into said attachment hole during an assembly;
said quick release/attachment assembly further comprising:
a lever arm having a first cam member with a first cam surface;
a central shaft extending from a pivot point of said lever arm at a proximate end to a bottom stop at a distal end;
means for adjusting a position of said bottom stop on said central shaft relative to said pivot point thereby allowing said quick release/attachment assembly to adapt to differing length attachment holes in said seat support;
a stability member about said central shaft at said proximate end having a second cam surface proximate said first cam surface;
at least one elastomeric sleeve on said central shaft between said bottom stop and said stability member; and
whereby when said lever arm actuates said first cam surface along said second cam surface, said bottom stop is drawn toward said pivot point compressing said elastomeric sleeve and bulging said sleeve away from said central shaft to grip walls of said seat attachment hole and join said seat attachment member to said seat support.

9. An attachment and adjustment kit, according to claim 8, further comprising:
at least one spacer on said central shaft; and
said at least one spacer being one of proximate said bottom stop and proximate said stability member

10. An attachment and adjustment kit, according to claim 8, wherein:
said means for adjusting includes a threaded connectability between said central shaft and said bottom stop, thereby allowing said bottom stop to be threadably adjusted along a length of said central shaft.

11. An attachment and adjustment kit, according to claim 8, wherein:
said elastomeric sleeve is at least one of a cylendraceous member, a hexagonal member, an octagonal member enabling simple operation and formation; and
an external surface of said elastomeric sleeve is at least one of a smooth surface, a roughened surface, a patterned surface, a particulate surface enabling firm fixing to a surface during use.

12. A kit, comprising:
a quick release/attachment assembly comprising:
a lever arm having a first cam member with a first cam surface;
a central shaft extending from a pivot point of said lever arm at a proximate end to a bottom stop at a distal end;
means for removing and adjusting a position of said bottom stop on said central shaft relative to said pivot point thereby allowing said quick release/attachment assembly to adapt to differing length operations;
a stability member about said central shaft at said proximate end having a second cam surface proximate said first cam surface;
at least one elastomeric sleeve on said central shaft between said bottom stop and said stability member; and
whereby when said lever arm actuates said first cam surface along said second cam surface, said bottom stop is drawn toward said pivot point compressing said elastomeric sleeve and bulging said sleeve away from said central shaft to grip walls of said seat attachment hole and join said seat attachment member to said seat support.

13. A kit, according to claim 12, further comprising:
a cover cap member; and
means for positioning said cover cap member covering a portion of said lever arm and said attachment assembly, whereby said cover cap member provides a pleasing visual appearance after installation.

14. A kit, according to claim 13, further comprising:
an opening on said cover cap member; and
a portion of said lever arm projecting through said opening enabling said cover cap member to provide said pleasing visual appearance while retaining a compact shape.
